(19) United States
(12) Patent Application Publication
(10) Pub. No.: US 2006/0024482 A1
(43) Pub. Date: Feb. 2, 2006

(54) Reinforced polymer composition

(76) Inventors: Zbigniew Henryk Stachurski, Canberra (AU); Floreana Coman, South Carlton (AU); Paul Compston, Canberra (AU)

Correspondence Address: DORSEY & WHITNEY LLP;INTELLECTUAL PROPERTY DEPARTMENT, 250 PARK AVENUE, NEW YORK, NY, 10177, US

(21) Appl. No.: 10/537,901

(22) PCT Filed: Dec. 4, 2003
(86) PCT No.: PCT/AU03/01617

§ 371 Date: Jun. 7, 2005

(30) Foreign Application Priority Data
Dec. 4, 2002 (AU) 200295099

(51) Int. Cl. B32B 3/00; D04H 1/00; B32B 27/12

(52) U.S. Cl. 428/292.1; 442/59; 442/394

(57) ABSTRACT

A partially cured reinforced polymeric article is provided which includes one or more layers. Each layer may include a reinforcing web, a partially cured cross-linkable polymeric composition being formed from, an ultra-violet (UV) curable polymeric resin; and a photoinitiator, and/or a photoinitiator and a thermal initiator. The polymeric resin and photoinitiator may be configured to permit formation of the partially cured cross-linkable polymeric composition in less than approximately 120 seconds.

The present invention relates to a cross-linkable polymeric fibre coating composition and method of preparing same. The invention also relates to articles formed using this process.

Continuous fibre reinforced polymer matrix materials (hereinafter referred to as “reinforced polymer materials”) are used for numerous flat and curved panel applications in the aerospace/aeromotive, industrial, chemical, building and sporting goods industries.

Traditionally, reinforced polymer materials are manufactured by the “lay-up” method. Fibres are laid over the mould and the polymer resin is poured and worked into the fibres, and cured in situ. The two most common and serious material defects in reinforced polymer materials are (i) poor wetting of the fibre by the resin with appearance of voids in the polymer matrix, and (ii) excessive wetting of the fibre with resin rich pocket creation. Both of these defects can prevent the material from reaching its maximum potential in mechanical properties and can cause premature failure of the material when in use. The lay-up method is unsuitable for achieving maximum mechanical properties in a consistent and reliable manner.

Partially cured reinforced polymer composites (hereinafter referred to as “prepregs” were developed in an attempt to overcome some of the disadvantages associated with reinforced polymer materials made according to the lay-up method. Prepregs are used generally for applications in specialist areas such as the aerospace industry.

The term “prepreg” as used herein refers to a partially cured article which comprises a reinforcing web or other such substrate impregnated with a polymeric matrix composition. The composite can be in rod, rope, fibre, roving, strand, tow, sheet or other form. A reinforcing sheet is preferred.

The “prepregging” method has been used in the prior art, for example in the aerospace industry, to (i) maximise the strength and stiffness of the materials, (ii) minimise the material defects of the materials, and (iii) to create material suitable for temporary storage and easy use. Prepreg materials may also be produced with consistent mechanical properties.

The prepregging method involves impregnating fibres (in a uniaxial or multiaxial continuous fabric form) with liquid resin in a manner that controls precisely the fibre-resin volume composition. The liquid resin may be partially cured, so that the resin becomes gel-like (ie: more viscous), but retains its adhesive and reactive properties. The process of partially curing the resin material is known as “B-staging”.

Multiple prepregs can then be consolidated into a shaped article.

Accordingly, it is the object of this invention to overcome, or at least alleviate one or more of the difficulties, and/or deficiencies, related to the prior art.

In a first aspect, there is provided a partially cured reinforced polymeric article which includes one or more layers, each layer including:
a reinforcing web;
a partially cured cross-linkable polymeric composition being formed from:
an ultra-violet (UV) curable polymeric resin; and
a photoinitiator; or
a photoinitiator and a thermal initiator
wherein the polymeric resin and photoinitiator are selected to permit formation of the partially cured cross-linkable polymeric composition in less than approximately 120 seconds.

The applicants have surprisingly found that by partially curing the composition in a first stage, a reinforced polymeric article may be prepared very rapidly, e.g. in a matter of seconds. This article may then be stored for an extended period in a suitable manner, and later used and shaped as required, before conducting the final UV and/or thermal cure of the composition.

Preferably, the partially cured cross-linkable polymeric composition is formed in approximately 5 to 60 seconds, more preferably in approximately 10 to 45 seconds.

The reinforcing web may be impregnated with the partially cured cross-linkable polymeric composition.

The polymeric article may include two or more layers. The layers may be of substantially the same thickness. Alternatively, one or more of the layers may be of differing thickness from one other layer in the article.

One or more layers in the article may include a reinforcing web of differing material from the reinforcing web of one other layer in the article. For example, the article may include alternating layers of glass fibre and carbon fibre.

The partially cured reinforced polymeric article remains in a pliable state so may be folded, or preferably rolled, for ease of storage and transportation, as discussed below.

Preferably, the partially cured reinforced polymeric article has a weight of from approximately 20 to 2000 g/m², preferably approximately 100 to 1500 g/m², more preferably 500 to 1000 g/m².

All types of fibre reinforcements or other reinforcing materials commonly used for these applications may be used as the reinforced web. Examples include, but are not limited to, one or more of glass fibres, carbon and graphite fibres, polymeric fibres (including aramide fibres), boron filaments, ceramic fibres, metal fibres, asbestos fibres, beryllium fibres, silica fibres and silicon carbide fibres. Glass fibres, in the form of fibreglass sheets or matts are preferred.

The UV curable polymeric resin material may include a curable polyester or vinyl ester resin. An epoxy vinyl ester resin is preferred. A bisphenol-A epoxy resin is particularly preferred. Examples include, but are not limited to, the Nuplex family of resins (polyester resins), and the Derakane family of resins (epoxy vinyl esters) (available from The Dow Chemical Company).

As stated above, the partial curing of the polymeric article is achieved by UV radiation.

Any commercially viable UV curing system may be used.

The photoinitiator may be present in any suitable amount to provide the desired level of curing. The amount of initiation may vary depending on the polyester or vinyl ester resin used. Preferably, the photoinitiator is present in an amount from 0.01% to 5% by weight. Most preferably, the photoinitiator is present in an amount from 0.1% to 2% by weight.

Examples of photoinitiators which may be used in the present process include, but are not limited to Ciba Geigy Irgacure 819, Ciba Geigy lrgacure184 (1-hydroxy cyclohexyl phenyl ketone), Ciba Geigy Irgacure 654 (benzildimethyl ketal), Ciba Geigy Irgacure 907 (2-methyl-1-{4-(methylthio)phenyl}-2-morpholino-propanone-1, Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

Examples of thermal initiators which may be used in the present process include, but are not limited to peroxides including benzoyl peroxide (BPO), cumene hydro peroxide (CHP), 1,1-di-tert-butyl peroxy-3,3,5-trimethylcyclo-hexane, and sec-isopropyl percarbonate.

The initiator may include a single component, or a combination of initiator components.

Other additives or modifiers may be present which are conventionally used in resin compositions. Such additives or modifiers may include: inhibitors, UV stabilisers, UV absorbers, antioxidants, tinting agents, transfer agents, viscosity modifiers, adhesion promoters/modifiers, colourants, fire resistance agents, antistatic agents, fillers, heat stabilisers, thixotropic agents, slip and blocking agents, and air release agents.

Accordingly, a further aspect of the present invention relates to a process for preparing a partially cured reinforced polymeric article including:
providing one or more layers, each layer including:
   a reinforcing web; and
   an effective amount of a cross-linkable polymeric composition including:
      a UV curable polymeric resin and
      a photoinitiator; or
      a photoinitiator and a thermal initiator;
   impregnating the reinforcing web with the cross-linkable polymeric composition; and
   exposing the impregnated web to a source of ultraviolet (UV) radiation for a period of less than approximately 120 seconds, at an intensity sufficient to partially cure the resin.

Preferably, the partially cured cross-linkable polymeric composition is formed in approximately 5 to 60 seconds, more preferably in approximately 10 to 45 seconds.

The partial UV curing of the resin material may be achieved with exposure of the prepreg to UV light with an intensity of from approximately 1×10⁻⁵ to 10×10⁻⁷ W/cm². More preferably, the intensity of the UV light is between 5×10⁻⁵ and 5×10⁻⁶ W/cm².

The partial UV curing of the resin material may be achieved with exposure of the prepreg to UV light for a time sufficient to achieve a desired level of curing. The exposure time is dependent on the light intensity selected but generally will extend from approximately 1 to 120 seconds, more preferably approximately 5 to 60 seconds, most preferably approximately 10 to 45 seconds.

It will be understood that the time of manufacture is accordingly very significantly reduced relative to prior art hand layering methods.

Preferably, the ratio of resin material to fibre material is between approximately 10 and 90% by weight.

More preferably, the ratio of resin material to fibre material is from 25 to 75%, more preferably by 35 to 65% by weight.

Once the prepregs have been partially cured, they are able to be stored. The prepregs may be stored indefinitely for periods up to 1 year when stored in a suitable manner (eg; prevented from exposure to UV light).

As discussed, the partially cured reinforced polymeric article is pliable and may be folded or rolled or otherwise packaged for ease of storage.

As the reinforced polymeric article preferably exhibits a significant degree of tack, one or more surfaces of the article may be provided with a protective layer, both to permit rolling and to avoid contamination with dust and the like during storage.

Accordingly, in a further aspect of the present invention there is provided a laminate polymeric article including a partially cured reinforced polymeric article as described above; and
a first protective coating or film overlaying at least a portion of a surface of the reinforced polymeric article.

The first protective coating or layer may be of any suitable material. A polymeric film or sheet may be used. A thermoplastic polymeric film such as a polyethylene, polypropylene or nylon film is preferred.

Where the reinforced polymeric article forms a sheet or film, the protective coating or layer may be applied to one, or preferably both, major surfaces thereof.

In a preferred embodiment of this aspect of the present invention, the partially cured reinforced polymer article may be provided with a protective coating or layer which is UV opaque. This may provide further protection against premature final cure.

The UV opaque protective coating may be provided by the first protective layer described above. However, preferably the UV opaque protective coating is a supplementary coating.

Accordingly, in a preferred embodiment, the laminated polymeric article further includes a UV opaque outer coating overlaying at least in part an exposed surface of the partially cured reinforced polymeric article or first protective coating or film.

For example, where the partially cured reinforced polymeric article is provided in a rolled form, the UV opaque outer coating may constitute an outer sheath or sleeve thereover.

The UV opaque outer coating may be of any suitable type. A metal material, such as an aluminium foil, may be used. A metal foil is preferred as it is both light and gas impervious and may, in addition, reduce or eliminate loss of volatiles from the partially cured polymeric material.

In a further aspect of the present invention, when required to be used, the partially cured polymeric article according to the present invention may be formed into a shaped article. The shaped article may then be subjected to a final curing step. The final cure may be achieved by UV radiation or heat.

Accordingly, in a further aspect of the present invention there is provided a process of forming a shaped article including:
shaping one or more partially cured reinforced polymeric articles (as described above) into a desired form; and
subjecting the formed article to a final curing step.

In a preferred form of the present invention, a final cure may include a UV curing step.

Accordingly the process according to this aspect of the present invention may further include exposing the formed article to a source of UV radiation for a period, and at an intensity, sufficient to achieve final cure.

When the resin system is formulated with a photoinitiator only, the final cure may be achieved through further exposure to UV light. The UV light intensity and exposure time is much greater than that used for the partial curing (or B-staging) step.

When the complete or final curing of the resin is achieved through a UV cure, the prepregs have a long shelf life, provided they are protected from further incidental UV exposure.

When the resin system is formulated with a photoinitiator and a thermal initiator, the final cure may be achieved at room temperature with exposure to a UV source, or preferably through use of an autoclave or other system which can apply heat and pressure to the composite laminate and provide a more rapid cure.

The intensity and duration of final cure is also dependent on the number of the partially cured reinforced articles (prepregs) utilised in forming the final shaped article. Whilst the relationships are not directly proportional, in general, as the number of layers increases, the intensity and/or duration increases.

The final UV curing of the resin material may be achieved with exposure of the prepreg to UV light with an intensity of from approximately 1×10⁻⁴ to 1×10⁻⁶ W/cm². More preferably, the intensity of the UV light is between approximately 5×10⁻⁴ and 5×10⁻⁵ W/cm².

The final UV curing of the resin material may be achieved with exposure of the prepreg a source of UV radiation for a time of from approximately 0.5 to 120 minutes. Preferably, the UV exposure is from approximately 1 minute to 60 minutes. More preferably, the UV exposure time is from approximately 10 to 45 minutes.

The final UV curing time depends on the number of layers to be cured and the resin/fibre ratio.

In an alternative embodiment, the final curing step may be, or include, a thermal curing.

The process according to this aspect of the present invention includes subjecting the formed article to a final curing step including applying heat to the shaped article at a temperature and for a period sufficient to achieve a final cure.

Preferably, the temperature of the final cure occurs at a temperature of between approximately 50 and 150° C. More preferably, the temperature is between approximately 65 and 100° C.

The final cure may be achieved with exposure of the formed article to heat for a time from approximately 30 minutes to 4 hours. The exposure time required depends on the curing temperature and the resin/fibre ratio.

Preferably, the pressure applied during the final cure is between approximately 30 and 100 psi. More preferably, the pressure is between 50 and 70 psi.

The thermal curing may be achieved using any suitable heat source. For example, the heat source may include, but is not limited to a heated press, a heated oven, a heated mould, and the like.

In a further aspect of the present invention there is provided a cured shaped article formed as described above.

The present invention will now be more fully described with reference to the accompanying examples. The examples describe UV B-staging for a number of systems with different fibre and resin combinations, and for two different UV B-staging processes.

It should be understood that the description following is illustrative only and should not be taken in any way as a restriction on the generality of the invention described above.

### EXAMPLES

General

The tack for each prepreg was measured using a floating roller peel test based on ASTM D3167. The average force to peel the prepreg from a rigid aluminium substrate is used as the measure of tack. Increasing tack force is consistent with an increase in resin mass fraction.

### Example 1

Glass/Polyester Prepreg for UV B-Staging and UV Final Cure

A polyester resin (Nuplex F61042) was formulated with 0.5 parts per hundred of Irgacure 819 photoinitiator. A quadraxial glass-fibre fibre fabric (1200 gsm) and a Twill glass-fibre fibre fabric (385 gsm) was impregnated with the liquid resin then passed under a 400 watt Mercury vapour lamp. The UV light intensity was 7×10⁻⁷ W/cm² and the exposure time ranged from 15 to 30 seconds.

The resin mass fraction was 35% in the Quadraxial prepreg and 50% in the Twill prepreg. The shelf life of these products is at least 6 months when protected from UV exposure. The final cure is achieved through further exposure of the article to UV light of the same source and wavelength as used in the B-staging step until the curing is complete.

### Example 2

Glass/Polyester Prepreg for UV B-Staging and UV Final Cure:

A polyester resin (Nuplex F61042) was formulated with 0.5 parts per hundred of Irgacure 819 photoinitiator. A woven roving glass-fibre fibre fabric (635 gsm) was impregnated with the liquid resin. B-staging was done under a UVA blacklight using 2×20 watt tubes. The UV intensity in the UVA range was approximately 4.7 mW/cm² and the exposure time was 10 seconds.

The resin mass fraction was 50%. The shelf life of this product is at least 6 months when protected from UV exposure. The final cure is achieved through further exposure of the article to UV light of the same source and wavelength as used in the B-staging step until the curing is complete.

### Example 3

Glass/Vinylester Prepreg for UV B-Staging and UV Final Cure:

A vinylester resin (Dow Derakane 411-350) was formulated with 0.5 parts per hundred of Irgacure 819 photoinitiator. A quadraxial glass-fibre fibre fabric (1200 gsm) was impregnated with the liquid resin in a 1:1 mass ratio, and then passed under UVA blacklight. The UV light intensity in the UVA range was approximately 4.7 mW/cm² and the exposure time was 10 seconds.

The resin mass fraction was 50%. The shelf life of this product is at least 6 months when protected from UV exposure. The final cure is achieved through further exposure of the article to UV light of the same source and wavelength as used in the B-staging step until the curing is complete.

### Example 4

Glass/Polyester Prepreg for UV B-Staging and Final Thermal Cure:

A polyester resin (Nuplex F61042) was formulated with 0.5 parts per hundred (pph) of Irgacure 819 photoinitiator, and 4 pph benzoyl peroxide (BPO) or 1 pph cumene hydro peroxide (CHP) thermal catalysts. A quadraxial glass-fibre fibre fabric (1200 gsm) was impregnated with the liquid resin in a 1:1 mass ratio, and then passed under UVA blacklight. The UV light intensity in the UVA range was approximately 4.7 mW/cm² and the exposure time was 10 seconds.

The shelf life of this product at room temperature is limited due to the presence of the thermal catalyst in the resin formulation. It must also be protected from UV exposure when stored. Final cure can be achieved through further UV exposure but this is example is specifically for manufacturers who prefer a thermal cure prepreg. The formulation with BPO will require 80° C. for 15-20 minutes. The formulation with CHP will require 100° C. for 10-15 minutes.

### Example 5

Glass/Vinylester Prepreg for UV B-Staging and Final Thermal Cure:

A vinylester resin (Dow Derakane 411-350) was formulated with 0.5 parts per hundred of Irgacure 819 photoinitiator, and 4 pph benzoyl peroxide (BPO) thermal catalyst. A quadraxial glass-fibre fibre fabric (1200 gsm) was impregnated with the liquid resin in a 1:1 mass ratio, and then passed under UVA blacklight. The UV light intensity in the UVA range was approximately 4.7 mW/cm² and the exposure time was 10 seconds.

The shelf life of this product at room temperature is limited due to the presence of the thermal catalyst in the resin formulation. It must also be protected from UV exposure when stored. Final cure can be achieved through further UV exposure but this is example is specifically for manufacturers who prefer a thermal cure prepreg. With BPO in the formulation, a thermal cure of 80° C. for approximately 20 minutes is required.

It will be understood that the invention disclosed and defined in this specification extends to all alternative combinations of two or more of the individual features mentioned or evident from the text or drawings. All of these different combinations constitute various alternative aspects of the present invention.

It will also be understood that the term “comprises” (or its grammatical variants) as used in this specification is equivalent to the term “includes” and should not be taken as excluding the presence of other elements or features.

1. A partially cured reinforced polymeric article comprising:
one or more layers, each of the layers including:
a reinforcing web;
a partially cured cross-linkable polymeric composition being formed from:
an ultra-violet (UV) curable polymeric resin; and
at least one of a photoinitiator or a combination of a photoinitiator and a thermal initiator,
wherein the polymeric resin and photoinitiator are configured to permit a formation of the partially cured cross-linkable polymeric composition in less than approximately 120 seconds.

2. A polymeric article according to claim 1, wherein the partially cured cross-linkable polymeric composition is formed in approximately 5 to 60 seconds.

3. A polymeric article according to claim 2, wherein the partially cured cross-linkable polymeric composition is formed in approximately 10 to 45 seconds.

4. A polymeric article according to claim 1, wherein the one or more layers include two or more layers and the layers are of substantially the same thickness.

5. A polymeric article according claim 1, wherein the one or more layers include two or more layers and one or more of the layers is of a differing thickness from another one of the layers in the article.

6. A polymeric article according to claim 1, wherein the one or more layers include two or more layers and one or more of the layers includes a reinforcing web of differing material from the material of another one of the layers in the article.

7. A polymeric article according to claim 1, wherein the cross-linkable polymeric composition is present in an amount between approximately 10% and 90% by weight.

8. A polymeric article according to claim 7, wherein the cross linkable polymeric composition is present in an amount between approximately 25% and 75% by weight.

9. A polymeric article according to claim 8, wherein the cross linkable polymeric composition is present in an amount between approximately 35% and 65% by weight.

10. A polymeric article according to claim 1, wherein the article has a weight of from approximately 20 to 2000 g/m².

11. A polymeric article according to claim 10, wherein the article has a weight of from approximately 100 to 1500 g/m².

12. A polymeric article according to claim 11, wherein the article has a weight of from approximately 500 to 1000 g/m².

13. A polymeric article according to claim 1, wherein the reinforcing web is at least one or more of glass fibres; carbon and graphite fibres, polymeric fibres, boron filaments, ceramic fibres, metal fibres, asbestos fibres, beryllium fibres, silica fibres and silicon carbide fibres.

14. A polymeric article according to claim 13, wherein the glass fibres are in the form of fibreglass sheets or matts.

15. A polymeric article according to claim 1, wherein the UV curable polymeric resin is at least one of a curable polyester, a vinyl ester resin, a epoxy vinyl ester resin and a bisphenol-A epoxy resin.

16. A polymeric article according to claim 1, wherein the photoinitiator is present in an amount of from 0.01% to 5% by weight.

17. A polymeric article according to claim 16, wherein the photoinitiator is present in an amount of from 0.1% to 0.2% by weight.

18. A polymeric article according to claim 1, wherein the photoinitiator is selected from the group consisting of Ciba Geigy Irgacure 819, Ciba Geigy Irgacure184 (1-hydroxy cyclohexyl phenyl ketone), Ciba Geigy Irgacure 654 (benzildimethyl ketal), Ciba Geigy Irgacure 907 (2-methyl-1-{4-(methylthio) phenyl}-2-morpholino-propanone-1), Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

19. A polymeric article according to claim 1, wherein the thermal initiator, if present, is selected from the group consisting of peroxides, 1,1-di-tert-butyl peroxy-3,3,5-trimethylcyclohexane, and sec-isopropyl percarbonate or a combination thereof.

20. A polymeric article according to claim 1, wherein the cross-linkable polymeric composition further includes an additive or modifier selected from the group consisting of inhibitors, UV stabilisers, UV absorbers, antioxidants, tinting agents, transfer agents, viscosity modifiers, adhesion promoters/modifiers, colourants, fire resistance agents, antistatic agents, fillers, heat stabilisers, thixotropic agents, slip and blocking agents, and air release agents or a combination thereof.

21. A process for preparing a partially cured reinforced polymeric article comprising:
providing one or more layers, each layer including:
a reinforcing web; and
an effective amount of a cross-linkable polymeric composition including at least one of:
a UV curable polymeric resin and a photoinitiator; or a combination of a photoinitiator and a thermal catalyst;
impregnating the reinforcing web with the cross-linkable polymeric composition; and
exposing the impregnated web to a source of ultraviolet (UV) radiation for a period of less than approximately 120 seconds, at an intensity sufficient to partially cure the resin.

22. A process according to claim 21, wherein the impregnated web is exposed to ultraviolet (UV) radiation for a period of from approximately 5 to 60 seconds.

23. A process according to claim 22, wherein the impregnated web is exposed to ultraviolet (UV) radiation for a period of from 10 to 45 seconds.

24. A process according to claim 21, wherein the intensity of the ultraviolet (UV) radiation is from approximately 1×1 0-5 to 10×1 0-7 W/cm².

25. A process according to claim 24, wherein the intensity of the ultraviolet (UV) radiation is from approximately 5×10-5 and 5×10′6 W/cm².

26. A process according to claims 21, wherein the polymeric article includes two or more layers, and the layers are of substantially the same thickness.

27. A process according to claims 21, wherein the polymeric article includes two or more layers, and one or more of the layers is of differing thickness from another one the layers in the article.

28. A process according to claims 21, wherein the polymeric article includes two or more layers, and one or more of the layers includes a reinforcing web of differing material from the material of another one the layers in the article.

29. A process according to claim 21, wherein the reinforcing web includes at least one glass fibres; carbon and graphite fibres, polymeric fibres, boron filaments, ceramic fibres, metal fibres, asbestos fibres, beryllium fibres, silica fibres and silicon carbide fibres.

30. A process according to claim 29, wherein the glass fibres are in the form of fibreglass sheets or matts.

31. A process according to claims 21, wherein the UV curable polymeric resin includes at least one of a curable polyester, a vinyl ester resin, a epoxy vinyl ester resin and a bisphenol-A epoxy resin.

32. A process according to claim 21, wherein the photoinitiator is present in an amount of from 0.01% to 5% by weight.

33. A process according to claim 32, wherein the photoinitiator is present in an amount of from 0.1% to 0.2% by weight.

34. A process according to claims 21, wherein the photoinitiator is selected from the group consisting of Ciba Geigy Irgacure 819, Ciba Geigy lrgacure184 (1-hydroxy cyclohexyl phenyl ketone), Ciba Geigy Irgacure 654 (benzildimethyl ketal), Ciba Geigy Irgacure 907 (2-methyl-1-{4-(methylthio) phenyl}-2-morpholino-propanone-1), Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

35. A process according to claim 21, wherein the thermal initiator, if present, is selected from the group consisting of peroxides, 1,1-di-tert-butyl peroxy-3,3,5-trimethylcyclohexane, and sec-isopropyl percarbonate or a combination thereof.

36. A process according to claims 21, wherein the cross-linkable polymeric composition further includes an additive or modifier selected from the group consisting of inhibitors, UV stabilisers, UV absorbers, antioxidants, tinting agents, transfer agents, viscosity modifiers, adhesion promoters/modifiers, colourants, fire resistance agents, antistatic agents, fillers, heat stabilisers, thixotropic agents, slip and blocking agents, and air release agents or a combination thereof.

37. A laminate polymeric article comprising:
a partially cured reinforced polymeric article which includes one or more layers, each layer including:
a reinforcing web;
a partially cured cross-linkable polymeric composition formed from:
an ultraviolet (UV) curable polymeric resin; and
a photoinitiator; or a combination of a photoinitiator and a thermal initiator; wherein the polymeric resin and the photoinitiator are configured to permit formation of the partially cured cross-linkable polymeric composition in less than approximately 120 seconds; and
a protective coating or film overlaying at least a portion of a surface of the reinforced polymeric article.

38. A laminate polymeric article according to claim 37, wherein the partially cured cross-linkable polymeric composition is formed in approximately 5 to 60 seconds.

39. A laminate polymeric article according to claim 38, wherein the partially cured cross-linkable polymeric composition is formed in approximately 10 to 45 seconds.

40. A laminate polymeric article according to claim 37, wherein the one or more layers include two or more layers and the layers are of substantially the same thickness.

41. A laminate polymeric article according to claim 37, wherein the one or more layers include two or more layers and one or more of the layers is of a differing thickness from another one the layers in the article.

42. A laminate polymeric article according to claim 37, wherein the one or more layers include two or more layers and one or more of the layers includes a reinforcing web of differing material from the material of another one the layers in the article.

43. A laminate polymeric article according to claim 37, wherein the cross-linkable polymeric composition is present in an amount between approximately 10 and 90% by weight.

44. A laminate polymeric article according to claim 43, wherein the cross linkable polymeric composition is present in an amount between approximately 25% and 75% by weight.

45. A laminate polymeric article according to claim 44, wherein the cross linkable polymeric composition is present in an amount between approximately 35% and 65% by weight.

46. A laminate polymeric article according to claim 37, wherein the article has a weight of from approximately 20 to 2000 g/m².

47. A laminate polymeric article according to claim 46, wherein the article has a weight of from approximately 100 to 1500 g/m².

48. A laminate polymeric article according to claim 47, wherein the article has a weight of from approximately 500 to 1000 g/m².

49. A laminate polymeric article according to claim 37, wherein the partially cured reinforced polymeric article includes two or more layers and the layers are of substantially the same thickness.

50. A laminate polymeric article according to claims 37, wherein the partially cured reinforced polymeric article includes two or more layers and one or more of the layers is of differing thickness from another one of the layers in the article.

51. A laminate polymeric article according to claim 37, wherein the partially cured reinforced polymeric article includes two or more layers and one or more of the layers includes a reinforcing web of differing material from the material of another one of the layers in the article.

52. A laminate polymeric article according to claim 37, wherein the protective coating or layer is applied to one major surface of the polymeric article.

53. A laminate polymeric article according to claim 37, wherein the protective coating or layer is applied to both major surfaces of the polymeric article.

54. A laminate polymeric article according to claim 37, wherein the first protective coating or film is a polymeric film or sheet.

55. A laminate polymeric article according to claim 54, wherein the polymeric film or sheet is a thermoplastic polymeric film.

56. A laminate polymeric article according to claim 55, wherein the thermoplastic polymeric film includes at least one of polyethylene, polypropylene or nylon film.

57. A laminate polymeric article according to claims 37, wherein the first protective coating or film is UV opaque.

58. A laminate polymeric article according to claims 37, further comprising a UV opaque outer coating overlaying, at least in part, an exposed surface of the partially cured reinforced polymeric article or the first protective coating or film.

59. A laminate polymeric article according to claim 58, wherein the UV opaque outer coating is a metal foil.

60. A laminate polymeric article according to claim 37, wherein the reinforcing web is at least one of glass fibres; carbon and graphite fibres, polymeric fibres, boron filaments, ceramic fibres, metal fibres, asbestos fibres, beryllium fibres, silica fibres and silicon carbide fibres.

61. A laminate polymeric article according to claim 60, wherein the glass fibres are in the form of fibreglass sheets or matts.

62. A laminate polymeric article according to claim 37, wherein the UV curable polymeric resin is at least one of a curable polyester, a vinyl ester resin, a epoxy vinyl ester resin and a bisphenol-A epoxy resin.

63. A laminate polymeric article according to claim 37, wherein the photoinitiator is present in an amount of from 0.01% to 5% by weight.

64. A laminate polymeric article according to claim 63, wherein the photoinitiator is present in an amount of from 0.1% to 0.2% by weight.

65. A laminate polymeric article according to claim 37, wherein photoinitiator is selected from the group consisting of Ciba Geigy Irgacure 819, Ciba Geigy Irgacure184 (1-hydroxy cyclohexyl phenyl ketone), Ciba Geigy Irgacure 654 (benzildimethyl ketal), Ciba Geigy Irgacure 907 (2-methyl-1-{4-(methylthio) phenyl}-2-morpholino-propanone-1), Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

66. A laminate polymeric article according to claim 37, wherein the thermal initiator, if present, is selected from the group consisting of peroxides, 1,1-di-tert-butyl peroxy-3,3,5-trimethylcyclohexane, and sec-isopropyl percarbonate or a combination thereof.

67. A laminate polymeric article according to claim 37, wherein the cross-linkable polymeric composition further includes an additive or modifier selected from the group consisting of inhibitors, UV stabilisers, UV absorbers, antioxidants, tinting agents, transfer agents, viscosity modifiers, adhesion promoters/modifiers, colourants, fire resistance agents, antistatic agents, fillers, heat stabilisers, thixotropic agents, slip and blocking agents, and air release agents or a combination thereof.

68. A process of forming a shaped article comprising: shaping one or more partially cured reinforced polymeric articles which include one or more layers, each layer including:
a reinforcing web;
a partially cured cross-linkable polymeric composition formed from:
an ultraviolet (UV) curable polymeric resin; and
a photoinitiator; or a combination of a photoinitiator and a thermal initiator; wherein the polymeric resin and the photoinitiator are configured to permit formation of the partially cured cross-linkable polymeric composition in less than approximately 120 seconds;
shaping one or more partially cured reinforced polymeric articles into a desired form; and
curing the formed article.

69. A process according to claim 68, wherein the partially cured cross-linkable polymeric composition is formed in approximately 5 to 60 seconds.

70. A process according to claim 69, wherein the partially cured cross-linkable polymeric composition is formed in approximately 10 to 45 seconds.

71. A process according to claim 68, wherein the partially cured reinforced polymeric article includes two or more layers and the layers are of substantially the same thickness.

72. A process according to claim 68 wherein the partially cured reinforced polymeric article includes two or more layers and one or more layers is of differing thickness from one other layer in the article.

73. A process according to claim 68, wherein the partially cured reinforced polymeric article includes two or more layers and one or more of the layers includes a reinforcing web of differing material from the material of another one of the layers in the article.

74. A process according to claim 68, wherein the curing step includes exposing the formed article to UV radiation.

75. A process according to claim 68, wherein the curing step includes applying heat and pressure to the formed articles.

76. A process according to claim 74, wherein the UV radiation has an intensity of from approximately 1×10⁻⁴ to 1×1 0⁻⁶ W/cm².

77. A process according to claim 76, wherein the UV radiation has an intensity of from approximately 5×10⁻⁴ to 5×10⁻⁶ W/cm².

78. A process according to claim 74, wherein the formed article is exposed to UV radiation for a period of from approximately 0.5 to 120 minutes.

79. A process according to claim 78, wherein the formed article is exposed to UV radiation for a period of from approximately 10 to 45 minutes.

80. A process according to claim 74, wherein the curing step includes subjecting the formed article to a thermal curing.

81. A process according to claim 80, wherein the temperature of the thermal curing is between approximately 50 and 150° C.

82. A process according to claim 81, wherein the temperature of the thermal curing is between approximately 65 and 100° C.

83. A process according to claim 75, wherein the pressure applied during the curing step is between approximately 30 and 100 psi.

84. A process according to claim 83, wherein the pressure applied during the curing step is between approximately 50 and 70 psi.

85. A process according to claims 68, wherein the reinforcing web is at least one of glass fibres; carbon and graphite fibres, polymeric fibres, boron filaments, ceramic fibres, metal fibres, asbestos fibres, beryllium fibres, silica fibres and silicon carbide fibres.

86. A process according to claim 85, wherein the glass fibres are provided in the form of fibreglass sheets or matts.

87. A process according to claim 68, wherein the UV curable polymeric resin is at least one of a curable polyester, a vinyl ester resin, a epoxy vinyl ester resin and a bisphenol-A epoxy resin.

88. A process according to claim 68, wherein the photoinitiator is present in an amount of from 0.01% to 5% by weight.

89. A process according to claim 88, wherein the photoinitiator is present in an amount of from 0.1% to 0.2% by weight.

90. A process according to claim 68, wherein the photoinitiator is selected from the group consisting of Ciba Geigy Irgacure 819, Ciba Geigy Irgacure184 (1-hydroxy cyclohexyl phenyl ketone), Ciba Geigy Irgacure 654 (benzildimethyl ketal), Ciba Geigy Irgacure 907 (2-methyl-1-{4-(methylthio) phenyl)-2-morpholino-propanone-1), Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

91. A process according to claim 68, wherein the thermal initiator, if present, is selected from the group consisting of peroxides, 1,1-di-tert-butyl proxy-3,3,5-trimethylcyclohexane, and sec-isopropyl percarbonate or a combination thereof.

92. A process according to claim 68, wherein the cross-linkable polymeric composition further includes an additive or modifier selected from the group consisting of inhibitors, UV stabilisers, UV absorbers, antioxidants, tinting agents, transfer agents, viscosity modifiers, adhesion promoters/modifiers, colourants, fire resistance agents, antistatic agents, fillers, heat stabilisers, thixotropic agents, slip and blocking agents, and air release agents or a combination thereof.

93. A cured shaped article comprising:
one or more partially cured, shaped and reinforced polymeric portions which include one or more layers, each layer including:
a reinforcing web,
a partially cured cross-linkable Polymeric composition formed from:
an ultraviolet (UV) curable Polymeric resin, and
a photoinitiator or a combination of a photoinitiator and a thermal initiator; wherein the Polymeric resin and the photoinitiator are configured to permit formation of the partially cured cross-linkable polymeric composition in less than approximately 120 seconds; and
one or more Partially cured reinforced Polymeric Portions which are shaped into a desired form, wherein the formed Polymeric portions are cured.
